(19) United States
(12) Patent Application Publication
(10) Pub. No.: US 2010/0218083 A1
(43) Pub. Date: Aug. 26, 2010

(54) DOCUMENT PROCESSING APPARATUS AND DOCUMENT PROCESSING METHOD

(75) Inventors: Masaki Tsujii, Tokushima (JP); Takashi Yoshida, Tokushima (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima-shi, Tokushima (JP)

(21) Appl. No.: 11/993,298

(22) PCT Filed: Jun. 26, 2006
(86) PCT No.: PCT/JP2006/312751

§ 371 Date: Dec. 20, 2007

(30) Foreign Application Priority Data
Jun. 24, 2005 (JP) 2005-185611

(51) Int. Cl. G06F 17/00

(52) U.S. Cl. 715/234; 715/243

(57) ABSTRACT

A screen is provided which integrally displays multiple documents.

A content integrating unit integrally displays a Web page acquired from a Web server, an interface which allows the user to transmit a query to a search service provided by a search engine, search results received from the search engine, etc., on a single content integrating screen. The content integrating unit provides an interface for receiving a request to register the Web content to be displayed on the content integrating screen, and a request to edit the layout of the display regions thereof. The content integrating unit allows the user to design the content integrating screen.

### TECHNICAL FIELD

The present invention relates to a document processing technique, and particularly to a document processing apparatus and a document processing method for processing a document described in a markup language.

### BACKGROUND ART

XML has been attracting attention as a format that allows the user to share data with other users via a network. This encourages the development of applications for creating, displaying, and editing XML documents (see Patent document 1, for example). The XML documents are created based upon a vocabulary (tag set) defined according to a document type definition.

In many cases, Web pages have been described in HTML (HyperText Markup Language). However, it is predicted that Web content described in XML such as XHTML or the like will increase in future. For example, RSS (RDF Site Summary), which is a format for describing the summary of a site in the form of meta data, has become widespread as a means for notifying users of site update information.

As a service provided by Web servers, there is a service which allows the user to register desired Web content which is to be browsed such as RSS content, a search engine query input interface, etc., and to design the layout thereof, thereby displaying this desired Web content on a single screen.

### [Patent Document 1]

Japanese Patent Application Laid-open No. 2001-290804

### DISCLOSURE OF THE INVENTION

### Problem to be Solved by the Invention

However, the kinds of available Web content which can be displayed on the screen are fixed by the server side. That is to say, such an arrangement does not allow the user to freely display desired Web content. Furthermore, such an arrangement permits only a low degree of freedom with respect to the screen layout. That is to say, such an arrangement does not allow the user to freely design a desired layout. Accordingly, there is a demand for a flexible service which permits a high degree of freedom, which allows the user to display desired Web content in a desired layout.

The present invention has been made in view of such a situation. Accordingly, it is a general purpose of the present invention to provide a technique for providing a screen which integrally displays multiple documents.

### Means to Solve the Problem

In order to solve the aforementioned problem, a document processing apparatus according to an embodiment of the present invention comprises: a document acquisition unit which acquires multiple XML documents from a server via a network; a definition file acquisition unit which acquires a first definition file which defines a rule for displaying the multiple XML documents on a single screen; and a display control unit which displays the multiple XML documents on the single screen according to the rule defined in the definition file.

Also, the definition file acquisition unit may further acquire a second definition file which defines a rule for displaying each of the multiple XML documents in a display region assigned to the corresponding XML document. Also, the display control unit may determine the layout of the display regions for displaying the multiple XML documents according to the rule described in the first definition file. Also, the display control unit may display each of the XML documents in the corresponding display region according to the rule described in the second definition file.

Also, the document processing apparatus may further comprise: a processing system which processes a document described in a predetermined tag set; and a conversion unit which maps the XML document to a tag set, which can be processed by the processing system, according to the rule described in the second definition file, and which retains the correspondence between the elements thus mapped.

Also, the document processing apparatus may further comprise a storage control unit which controls the storage of the multiple XML documents displayed on the screen. With such an arrangement, the storage control unit may store each XML document without it being converted by the conversion unit.

Also, the document processing apparatus may further comprise a conditions retention unit which retains a rule for changing a display format according to a condition with respect to data included in the XML document. With such an arrangement, in a case in which the data included in the XML document matches the condition, the display control unit may change the display format of the XML document according to the rule.

Also, the document processing apparatus may further comprise an update control unit which updates at least a part of the XML document. With such an arrangement, upon reception of information specified by the user with respect to the XML document to be updated, the update control unit may instruct the document acquisition unit to re-acquire the XML document thus specified, and may instruct the display control unit to display the XML document thus re-acquired.

Also, the document processing apparatus may further comprise a screen editing unit which provides an interface for receiving a request to edit the screen which displays the multiple XML documents. With such an arrangement, the screen editing unit may receive a request to register the XML documents to be displayed on the screen. Also, the screen editing unit may describe a rule in the first definition file, which are used for displaying the XML documents on the screen, according to the request thus received.

Also, an arrangement may be made in which, upon reception of a request to modify the layout of the display regions of the XML documents displayed on the screen, the screen editing unit edits the rule described in the first definition file.

Another embodiment of the present invention relates to a document processing method. The document processing method comprises: acquisition of multiple XML documents from a server via a network; acquisition of a first definition file that defines a rule for displaying the multiple XML documents on a single screen; and display of the multiple XML documents on a single screen according to the rule defined in the definition file.

It should be noted that any combination of the aforementioned components or any manifestation of the present invention realized by modification of a method, device, system, and so forth, is effective as an embodiment of the present invention.

### ADVANTAGE OF THE PRESENT INVENTION

The present invention provides a screen which integrally displays multiple documents.

### BRIEF DESCRIPTION OF THE DRAWINGS

FIG. 1 is a diagram which shows a configuration of a document processing apparatus according to the Background Art.

FIG. 2 is a diagram which shows an example of an XML document which is to be edited by the document processing apparatus.

FIG. 3 is a diagram which shows an example in which the XML document shown in FIG. 2 is mapped to a table described in HTML.

FIG. 4(a) is a diagram which shows an example of a definition file used for mapping the XML document shown in FIG. 2 to the table shown in FIG. 3.

FIG. 4(b) is a diagram which shows an example of a definition file used for mapping the XML document shown in FIG. 2 to the table shown in FIG. 3.

FIG. 5 is a diagram which shows an example of a screen on which the XML document shown in FIG. 2 is displayed after having been mapped to HTML according to the correspondence shown in FIG. 3.

FIG. 6 is a diagram which shows an example of a graphical user interface provided by a definition file creating unit, which allows the user to create a definition file.

FIG. 7 is a diagram which shows another example of a screen layout created by the definition file creating unit.

FIG. 8 is a diagram which shows an example of an editing screen for an XML document, as provided by the document processing apparatus.

FIG. 9 is a diagram which shows another example of an XML document which is to be edited by the document processing apparatus.

FIG. 10 is a diagram which shows an example of a screen on which the document shown in FIG. 9 is displayed.

FIG. 11 is a diagram which shows a configuration of a document processing apparatus according to an embodiment.

FIG. 12 is a diagram which shows an internal configuration of a content integrating unit.

FIG. 13 is a diagram which shows an example of a content integrating screen displayed by a display control unit.

FIG. 14 is a diagram which shows an example of a content integrating screen displayed according to the conditions retained by a display conditions retention unit.

FIG. 15 is an example of a content integrating screen after a part of the content has been updated by an update control unit.

FIG. 16 is a diagram which shows an example of a content integrating screen in which data is shared among content by a data sharing control unit.

### DESCRIPTION OF THE REFERENCE NUMERALS

20 document processing apparatus, 22 main control unit, 24 editing unit, 25 Web server, 27 search engine, 30 DOM unit, 32 DOM provider, 34 DOM builder, 36 DOM writer, 40 CSS unit, 42 CSS parser, 44 CSS provider, 46 rendering unit, 50 HTML unit, 52, 62 control unit, 54, 64 editing unit, 56, 66 display unit, 60 SVG unit, 70 content integrating unit, 71 content acquisition unit, 73 display control unit, 74 display conditions retention unit, 75 update control unit, 76 storage control unit, 77 data sharing control unit, 80 VC unit, 82 mapping unit, 84 definition file acquisition unit, 86 definition file creating unit, 100 document processing apparatus

### BEST MODE FOR CARRYING OUT THE INVENTION

Base Technology

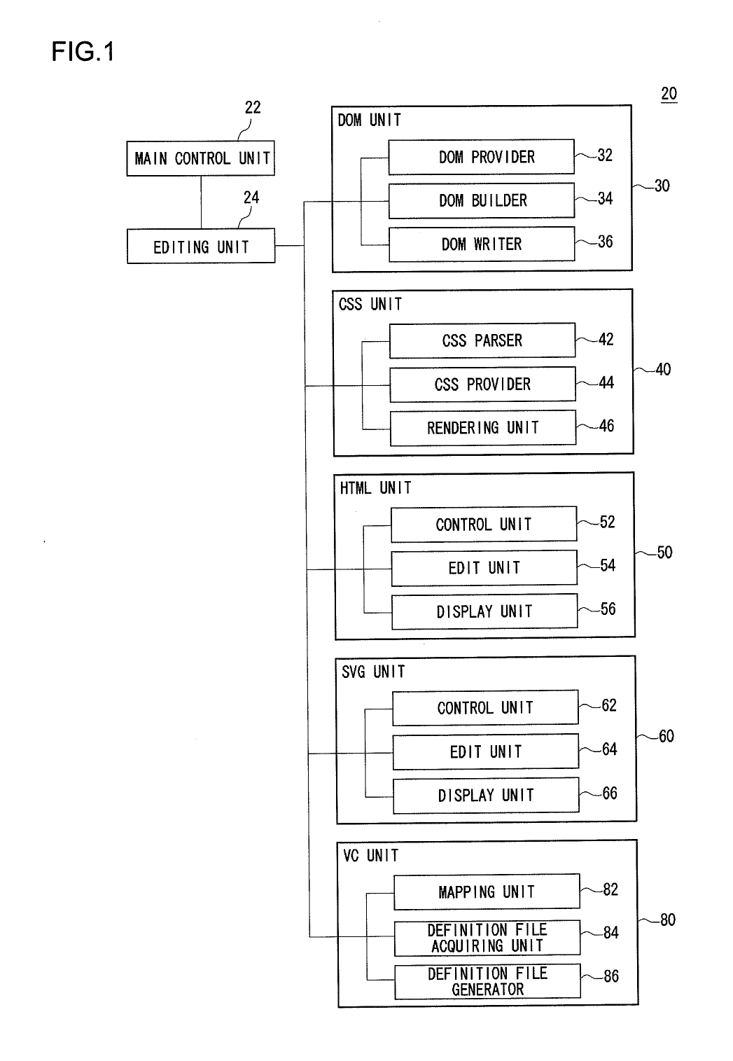

FIG. 1 illustrates a structure of a document processing apparatus 20 according to Base Technology. The document processing apparatus 20 processes a structured document where data in the document are classified into a plurality of components having a hierarchical structure. Represented in Base Technology is an example in which an XML document, as one type of a structured document, is processed. The document processing apparatus 20 is comprised of a main control unit 22, an editing unit 24, a DOM unit 30, a CSS unit 40, an HTML unit 50, an SVG unit 60 and a VC unit 80 which serves as an example of a conversion unit. In terms of hardware components, these unit structures may be realized by any conventional processing system or equipment, including a CPU or memory of any computer, a memory-loaded program, or the like. Here, the drawing shows a functional block configuration which is realized by cooperation between the hardware components and software components. Thus, it should be understood by a person skilled in the art that these functional blocks can be realized in a variety of forms by hardware only, software only or the combination thereof.

The main control unit 22 provides for the loading of a plug-in or a framework for executing a command. The editing unit 24 provides a framework for editing XML documents. Display and editing functions for a document in the document processing apparatus 20 are realized by plug-ins, and the necessary plug-ins are loaded by the main control unit 22 or the editing unit 24 according to the type of document under consideration. The main control unit 22 or the editing unit 24 determines which vocabulary or vocabularies describes the content of an XML document to be processed, by referring to a name space of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, HTML unit 50 and the SVG unit 60 are loaded, respectively. As will be described later, when compound documents, which contain both HTML and SVG components, are to be processed, both HTML unit 50 and the SVG unit 60 are loaded.

By implementing the above structure, a user can select so as to install only necessary functions, and can add or delete a function or functions at a later stage, as appropriately. Thus, the storage area of a recording medium, such as a hard disk, can be effectively utilized, and the wasteful use of memory can be prevented at the time of executing programs. Furthermore, since the capability of this structure is highly expandable, a developer can deal with new vocabularies in the form of plug-ins, and thus the development process can be readily facilitated. As a result, the user can also add a function or functions easily at low cost by adding a plug-in or plug-ins.

The editing unit 24 receives an event, which is an editing instruction, from the user via the user interface. Upon reception of such an event, the editing unit 24 notifies a suitable plug-in or the like of this event, and controls the processing such as redoing this event, canceling (undoing) this event, etc.

The DOM unit 30 includes a DOM provider 32, a DOM builder 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the editing unit 24. The DOM builder 34 creates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are created. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

HTML unit 50 displays or edits documents described in HTML. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an edit unit (also designated herein as a “zone”) 54 and 64, which edits the DOM according to the editing commands. Upon the control unit 52 or 62 receiving a DOM tree editing command from an external source, the edit unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the edit units 54 and 64 and DOM instance corresponds to “Model”. The document processing apparatus 20 according to the Base Technology allows an XML document to be edited according to each given vocabulary, as well as providing a function of editing HTML document in the form of tree display. HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file generator 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the Base Technology, this function is called a vocabulary connection (VC). In the VC unit 80, the definition file acquiring unit 84 acquires a script file in which the mapping definition is described. Here, the definition file specifies the correspondence (connection) between the Nodes for each Node. Furthermore, the definition file may specify whether or not editing of the element values or attribute values is permitted. Furthermore, the definition file may include operation expressions using the element values or attribute values for the Node. Detailed description will be made later regarding these functions. The mapping unit 82 instructs the DOM builder 34 to create a destination tree with reference to the script file acquired by the definition file acquiring unit 84. This manages the correspondence between the source tree and the destination tree. The definition file generator 86 offers a graphical user interface which allows the user to create a definition file.

The VC unit 80 monitors the connection between the source tree and the destination tree. Upon reception of an editing instruction from the user via a user interface provided by a plug-in that handles a display function, the VC unit 80 first modifies a relevant Node of the source tree. As a result, the DOM unit 30 issues a mutation event indicating that the source tree has been modified. Upon reception of the mutation event thus issued, the VC unit 80 modifies a Node of the destination tree corresponding to the modified Node, thereby updating the destination tree in a manner that synchronizes with the modification of the source tree. Upon reception of a mutation event that indicates that the destination tree has been modified, a plug-in having functions of displaying/editing the destination tree, e.g., HTML unit 50, updates a display with reference to the destination tree thus modified. Such a structure allows a document described in any vocabulary, even a minor vocabulary used in a minor user segment, to be converted into a document described in another major vocabulary. This enables such a document described in a minor vocabulary to be displayed, and provides an editing environment for such a document.

An operation in which the document processing apparatus 20 displays and/or edits documents will be described herein below. When the document processing apparatus 20 loads a document to be processed, the DOM builder 34 creates a DOM tree from the XML document. The main control unit 22 or the editing unit 24 determines which vocabulary describes the XML document by referring to a name space of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and creates a destination tree according to the definition, so that the document is displayed/edited by the plug-in corresponding to the vocabulary which is to be used for mapping. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out on the display screen.

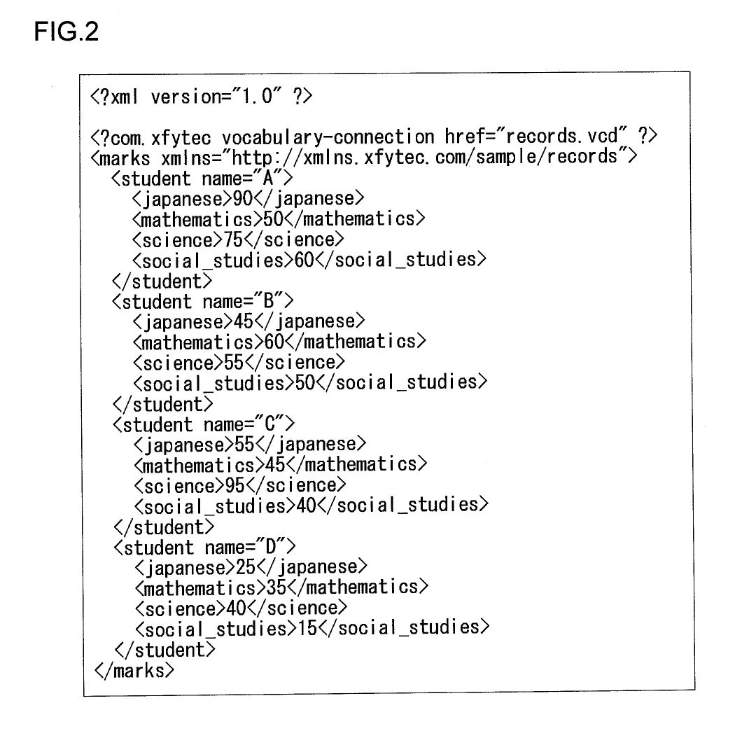

FIG. 2 shows an example of an XML document to be processed. According to this exemplary illustration, the XML document is used to manage data concerning grades or marks that students have earned. A component “marks”, which is the top Node of the XML document, includes a plurality of components “student” provided for each student under “marks”. The component “student” has an attribute “name” and contains, as child elements, the subjects “japanese”, “mathematics”, “science”, and “social_studies”. The attribute “name” stores the name of a student. The components “japanese”, “mathematics”, “science” and “social_studies” store the test scores for the subjects Japanese, mathematics, science, and social studies, respectively. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the Base Technology does not have a plug-in which conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. Note that description will be made later regarding a user interface that allows the user to create the user's own definition file. Now, description will be made below regarding a case in which a definition file has already been prepared.

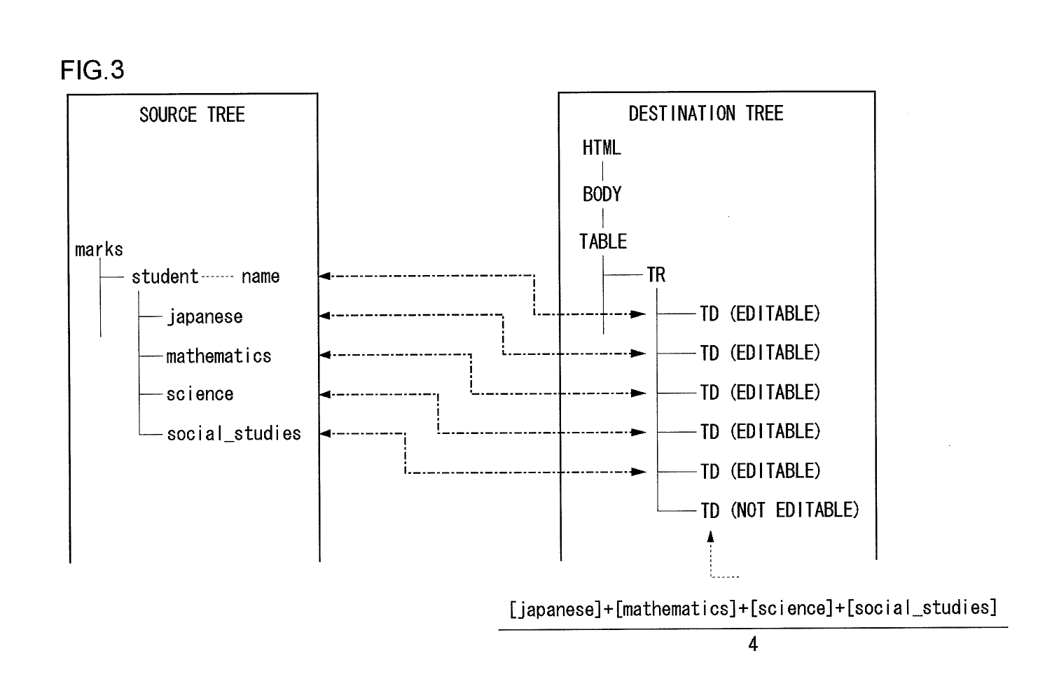

FIG. 3 shows an example in which the XML document shown in FIG. 2 is mapped to a table described in HTML. In an example shown in FIG. 3, a “student” Node in the marks managing vocabulary is associated with a row (“TR” Node) of a table (“TABLE” Node) in HTML. The first column in each row corresponds to an attribute value “name”, the second column to a “japanese” Node element value, the third column to a “mathematics” Node element value, the fourth column to a “science” Node element value and the fifth column to a “social_studies” Node element value. As a result, the XML document shown in FIG. 2 can be displayed in an HTML tabular format. Furthermore, these attribute values and element values are designated as being editable, so that the user can edit these values on a display screen using an editing function of HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example shown in FIG. 3, editing is designated as not being possible in the sixth column, so that the average value alone cannot be edited individually. Thus, in the mapping definition it is possible to specify editing or no editing so as to protect the users against the possibility of performing erroneous operations.

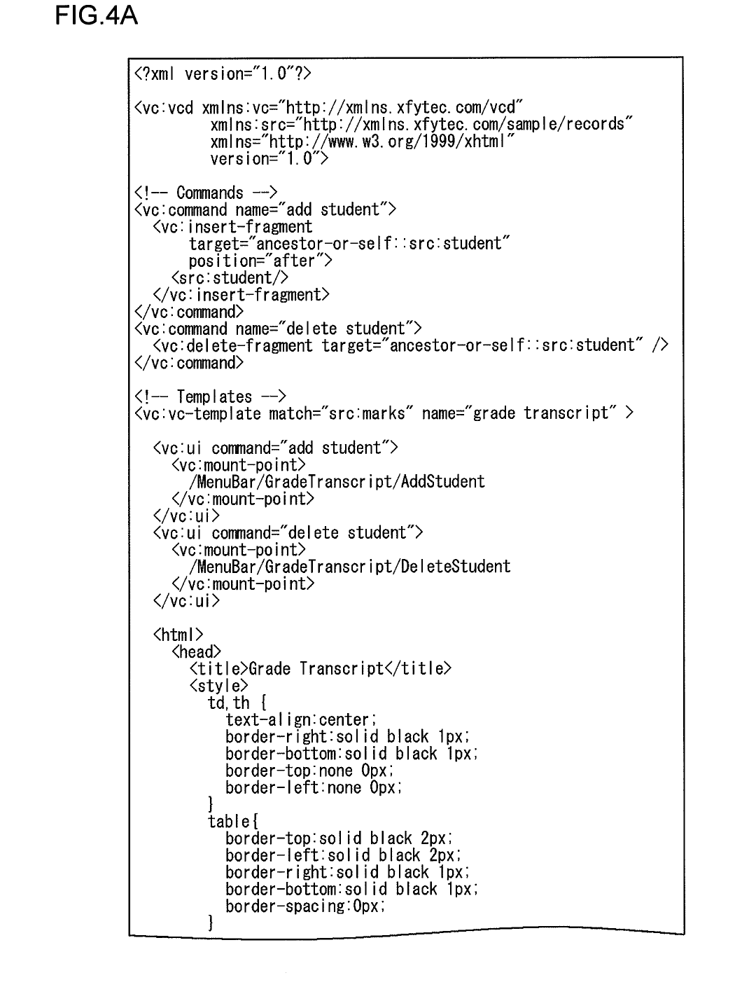

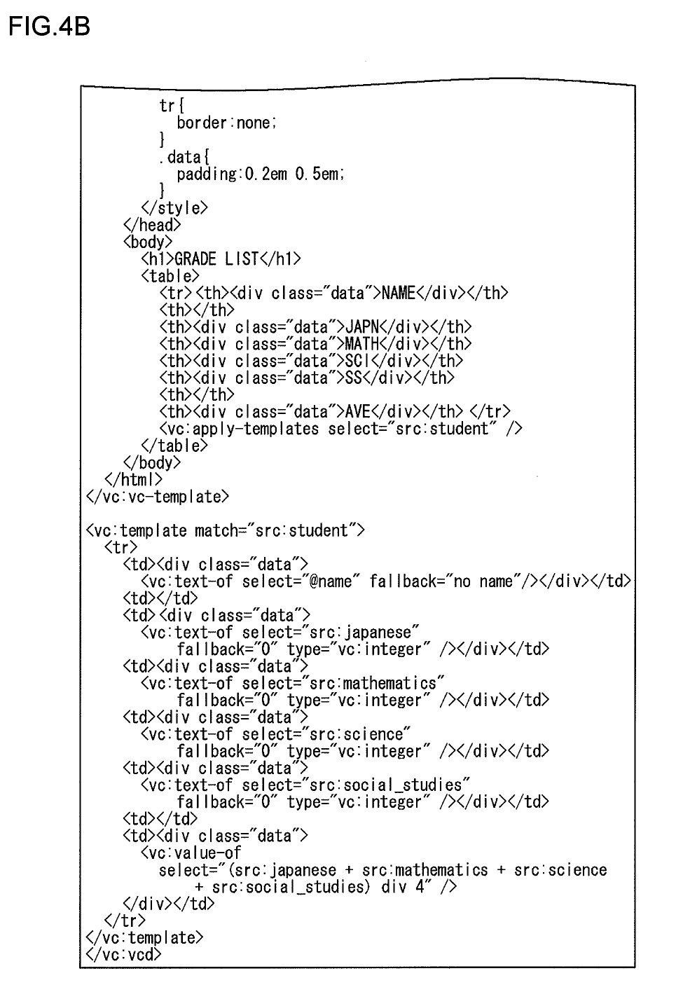

FIG. 4(a) and FIG. 4(b) illustrate an example of a definition file to map the XML document shown in FIG. 2 to the table shown in FIG. 3. This definition file is described in script language defined for use with definition files. In the definition file, definitions of commands and templates for display are described. In the example shown in FIG. 4(a) and FIG. 4(b), “add student” and “delete student” are defined as commands, and an operation of inserting a Node “student” into a source tree and an operation of deleting the Node “student” from the source tree, respectively, are associated with these commands. Furthermore, the definition file is described in the form of a template, which describes that a header, such as “name” and “japanese”, is displayed in the first row of a table and the contents of the Node “student” are displayed in the second and subsequent rows. In the template displaying the contents of the Node “student”, a term containing “text-of” indicates that editing is permitted, whereas a term containing “value-of” indicates that editing is not permitted. Among the rows where the contents of the Node “student” are displayed, an operation expression “(src:japanese+src:mathematics+scr:science+scr:social_studies) div 4” is described in the sixth row. This means that the average of the student's marks is displayed.

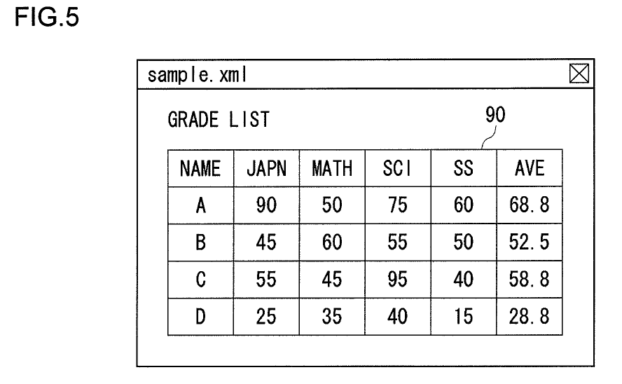

FIG. 5 shows an example of a display screen on which an XML document described in the marks managing vocabulary shown in FIG. 2 is displayed by mapping the XML document to HTML using the correspondence shown in FIG. 3. Displayed from left to right in each row of a table 90 are the names of each student, marks for Japanese, marks for mathematics, marks for science, marks for social studies and the averages thereof. The user can edit the XML document on this screen. For example, when the value in the second row and the third column is changed to “70”, the element value in the source tree corresponding to this Node, that is, the marks of student “B” for mathematics are changed to “70”. At this time, in order to have the destination tree follow the source tree, the VC unit 80 changes a relevant portion of the destination tree accordingly, so that HTML unit 50 updates the display based on the destination tree thus changed. Hence, the marks of student “B” for mathematics are changed to “70”, and the average is changed to “55” in the table on the screen.

On the screen as shown in FIG. 5, commands like “add student” and “delete student” are displayed in a menu as defined in the definition file shown in FIG. 4(a) and FIG. 4(b). When the user selects a command from among these commands, a Node “student” is added or deleted in the source tree. In this manner, with the document processing apparatus 20 according to the Base Technology, it is possible not only to edit the element values of components in a lower end of a hierarchical structure but also to edit the hierarchical structure. An edit function for editing such a tree structure may be presented to the user in the form of commands. Furthermore, a command to add or delete rows of a table may, for example, be linked to an operation of adding or deleting the Node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of HTML unit 50.

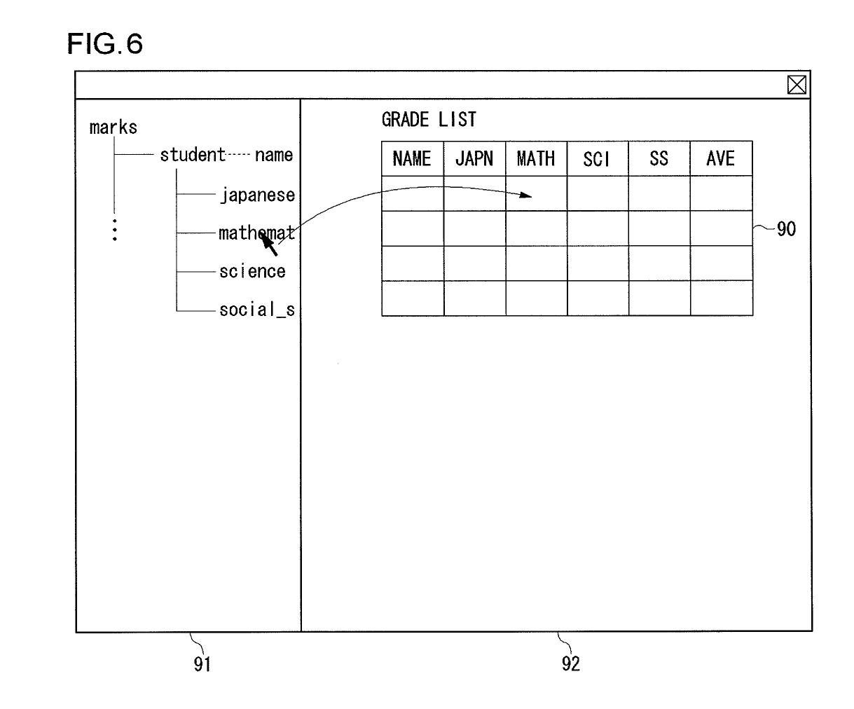

FIG. 6 shows an example of a graphical user interface, which the definition file generator 86 presents to the user, in command for the user to create a definition file. An XML document to be mapped is displayed in a tree in a left-hand area 91 of a screen. The screen layout of an XML document after mapping is displayed in a right-hand area 92 of the screen. This screen layout can be edited by HTML unit 50, and the user creates a screen layout for displaying documents in the right-hand area 92 of the screen. For example, a Node of the XML document which is to be mapped, which is displayed in the left-hand area 91 of the screen, is dragged and dropped into HTML screen layout in the right-hand area 92 of the screen using a pointing device such as a mouse, so that a connection between a Node at a mapping source and a Node at a mapping destination is specified. For example, when “mathematics,” which is a child element of the element “student,” is dropped to the intersection of the first row and the third column in a table 90 on HTML screen, a connection is established between the “mathematics” Node and a “TD” Node in the third column. Either editing or no editing can be specified for each Node. Moreover, the operation expression can be embedded in a display screen. When the screen editing is completed, the definition file generator 86 creates definition files, which describe connections between the screen layout and Nodes.

Viewers or editors which can handle major vocabularies such as XHTML, MathML and SVG have already been developed. However, it does not serve any practical purpose to develop dedicated viewers or editors for such documents described in the original vocabularies as shown in FIG. 2. If, however, the definition files for mapping to other vocabularies are created as mentioned above, the documents described in the original vocabularies can be displayed and/or edited utilizing the VC function without the need to develop a new viewer or editor.

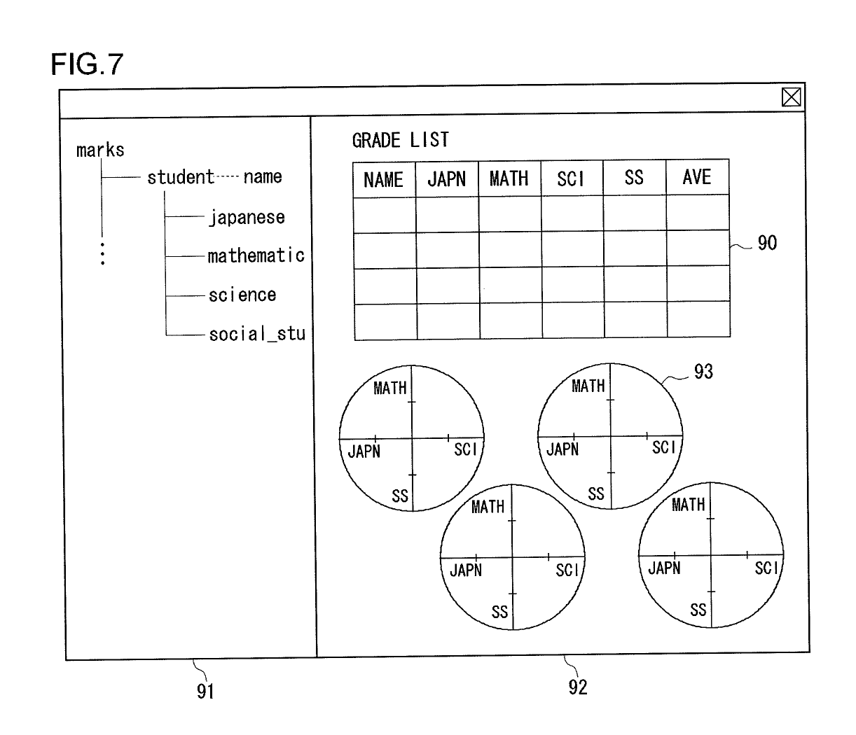

FIG. 7 shows another example of a screen layout created by the definition file generator 86. In the example shown in FIG. 7, a table 90 and circular graphs 93 are created on a screen for displaying XML documents described in the marks managing vocabulary. The circular graphs 93 are described in SVG. As will be discussed later, the document processing apparatus 20 according to the Base Technology can process a compound document described in the form of a single XML document according to a plurality of vocabularies. That is why the table 90 described in HTML and the circular graphs 93 described in SVG can be displayed on the same screen.

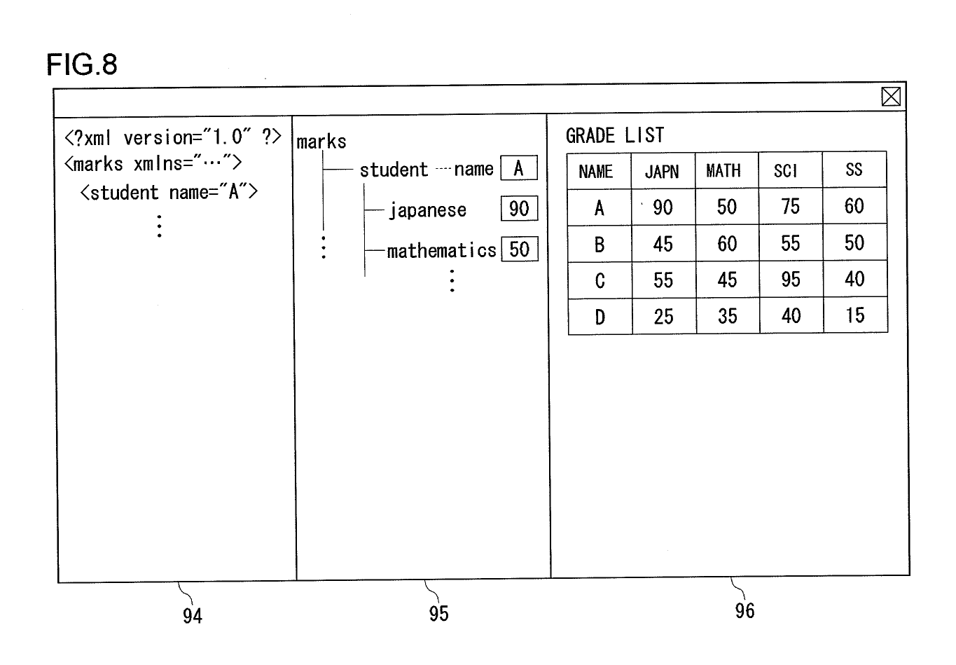

FIG. 8 shows an example of a display medium, which in a preferred but non-limiting embodiment is an edit screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table shown in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective edit screens are registered in advance as listeners for mutation events that provide notice of a change in the source tree. When the source tree is modified by any of the plug-ins or the VC unit 80, all the display units, which are displaying the edit screen, receive the issued mutation event(s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree-view display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, HTML unit 50 in charge of displaying the area 96 updates the screen by referring to the destination tree, which has been modified following the modification of the source tree.

The source display and the tree-view display can also be realized by utilizing the VC function. That is to say, an arrangement may be made in which the source and the tree structure are laid out in HTML, an XML document is mapped to HTML structure thus laid out, and HTML unit 50 displays the XML document thus mapped. In such an arrangement, three destination trees in the source format, the tree format and the table format are created. If the editing is carried out in any of the three areas on the screen, the VC unit 80 modifies the source tree and, thereafter, modifies the three destination trees in the source format, the tree format and the table format. Then, HTML unit 50 updates the three areas of the screen by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

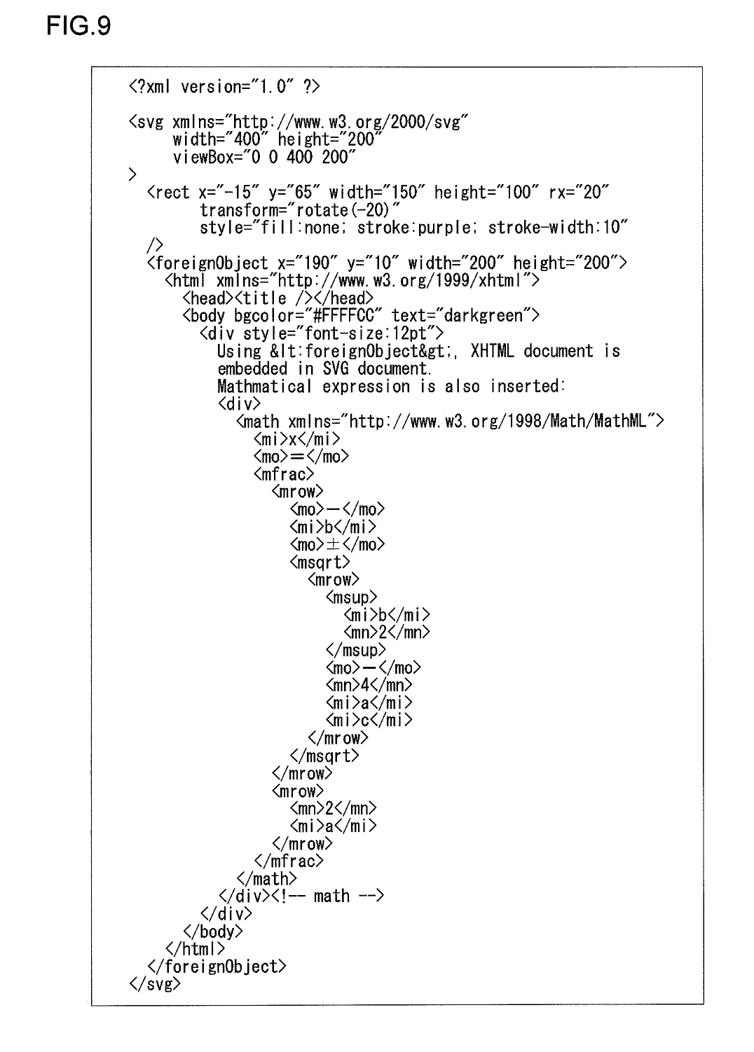

FIG. 9 illustrates another example of an XML document edited by the document processing apparatus 20. In the XML document shown in FIG. 9, an XHTML document is embedded in a “foreignObject” tag of an SVG document, and the XHTML document contains an equation described in MathML. In this case, the editing unit 24 assigns the rendering job to an appropriate display system by referring to the name space. In the example illustrated in FIG. 9, first, the editing unit 24 instructs the SVG unit 60 to render a rectangle, and then instructs HTML unit 50 to render the XHTML document.

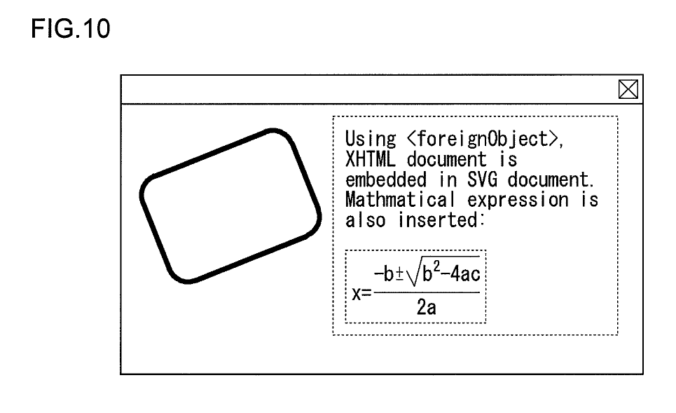

Furthermore, the editing unit 24 instructs a MathML unit (not shown) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set which is defined in the definition file for mapping the SVG document, is displayed. On the other hand, when the cursor lies in an area where the XHTML document is displayed, the menu provided by HTML unit 50, or a command set which is defined in the definition file for mapping HTML document, is displayed. Thus, an appropriate user interface can be presented according to the editing position.

In a case that there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a particular document, their contents cannot be displayed without the installation of an application to display the embedded document. According to the Base Technology, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a single compound document, a part of the compound document described in a given vocabulary can be used as reference data for another part of the same compound document described in a different vocabulary. Furthermore, when a search is made within the document, a string of characters embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used so as to display a portion surrounding these tags in an emphasized manner, or may be sorted out in the command of importance.

When the user edits a document on an edit screen as shown in FIG. 10, a plug-in or a VC unit 80, which is in charge of processing the edited portion, modifies the source tree. A listener for mutation events can be registered for each Node in the source tree. Normally, a display unit of the plug-in or the VC unit 80 conforming to a vocabulary that belongs to each Node is registered as the listener. When the source tree is modified, the DOM provider 32 traces toward a higher hierarchy from the modified Node. If there is a registered listener, the DOM provider 32 issues a mutation event to the listener. For example, referring to the document shown in FIG. 9, if a Node which lies lower than the <html> Node is modified, the mutation event is notified to HTML unit 50, which is registered as a listener to the <html> Node. At the same time, the mutation event is also notified to the SVG unit 60, which is registered as a listener in an <svg> Node, which lies upper to the <html> Node. At this time, HTML unit 50 updates the display by referring to the modified source tree. Since the Nodes belonging to the vocabulary of the SVG unit 60 itself are not modified, the SVG unit 60 may disregard the mutation event.

Depending on the contents of the editing, modification of the display by HTML unit 50 may change the overall layout. In such a case, the layout is updated by a screen layout management mechanism, e.g., the plug-in that handles the display of the highest Node, in increments of display regions which are displayed according to the respective plug-ins. For example, in a case of expanding a display region managed by HTML unit 50, first, HTML unit 50 renders a part managed by HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

### Embodiment

In the embodiment, a technique is proposed which provides an environment that allows the user to freely design the screen for integrally displaying multiple Web content.

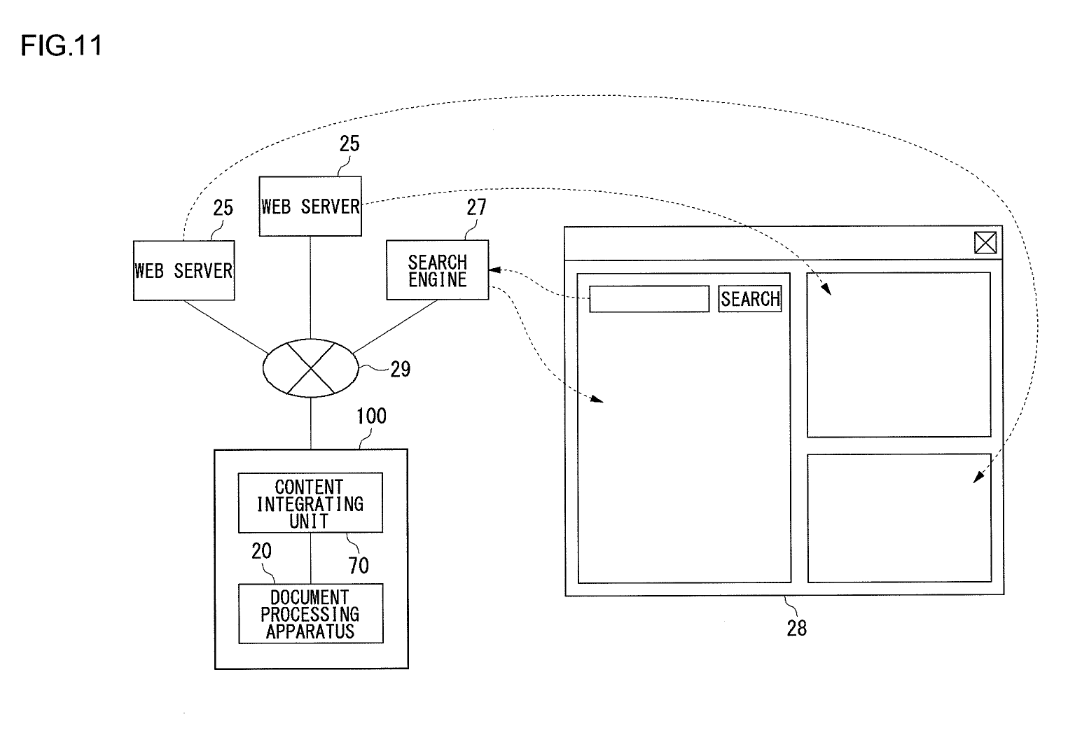

FIG. 11 is a diagram which shows a configuration of a document processing apparatus 100 according an embodiment. The document processing apparatus 100 includes a content integrating unit 70 in addition to the configuration of the document processing apparatus 20 described in the base technology. In an example shown in FIG. 11, the document processing apparatus 100 serves as a Web browser for browsing Web pages described in HTML or XML stored on Web servers 25. The content integrating unit 70 requests the Web servers 25 to transmit Web content such as Web pages via the Internet 29, thereby acquiring the Web content. Furthermore, the content integrating unit 70 transmits a search query to a search engine 27 via the Internet 29, thereby acquiring the search results. The content integrating unit 70 integrally displays the multiple Web content thus acquired on a single screen 28 (which will be referred to as the “content integrating screen” hereafter).

The content integrating unit 70 provides an environment which allows the user to freely design the layout of the display regions on a screen for displaying Web content such as Web pages, RSS content, etc., interface regions for displaying the interfaces such as a search keyword input screen provided by a search service, etc., thereby displaying the screen 28 which allows the user to integrally browse desired information. Such functions can be realized by the definition file and the VC unit 80 described in the base technology. With such an arrangement, the definition file creating unit 86 allows the user to register Web content, the interfaces of Web applications, Web services, etc., which are to be displayed on the screen, and to set the layout of the screen.

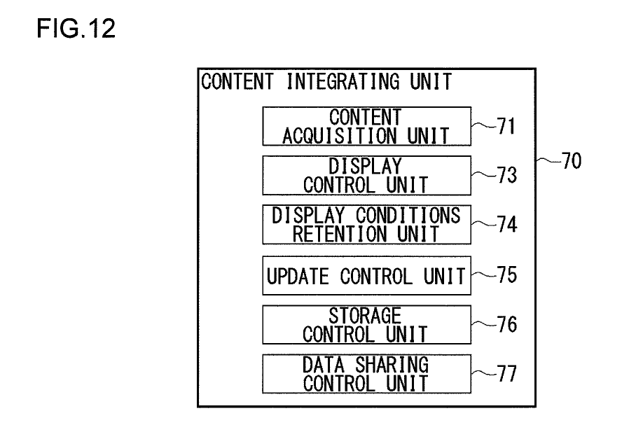

FIG. 12 shows an internal configuration of the content integrating unit 70. The content integrating unit 70 includes a content acquisition unit 71, a display control unit 73, a display conditions retention unit 74, an update control unit 75, a storage control unit 76, and a data sharing control unit 77.

The content acquisition unit 71 acquires Web content such as Web pages etc., from Web service provider servers such as the Web servers 25, the search engines 27, etc. The Web content to be acquired may be described in a definition file. Upon the user opening a document held by the document processing apparatus 100, which displays the content integrating screen 28, the definition file acquisition unit 84 acquires a first definition file for integrating the Web content associated with this document. The content acquisition unit 71 acquires the content described in the definition file or the document. Here, available content which can be acquired includes: Web pages provided by the Web servers 25, RSS content, content such as music content, motion images, etc., search results provided by the search engines 27. Each Web page may be described in HTML or a specific vocabulary (tag set) of XML.

The display control unit 73 integrally displays the multiple Web content acquired by the content acquisition unit 71. The display rules for displaying the Web content may be described in the definition file. For example, the display format of each kind of Web content may be defined in a second definition file associated with this Web content. Furthermore, the display rules for laying out the display regions of the Web content on a single screen may be defined in the aforementioned first definition file for integrating the Web content.

The first definition file defines the layout of the display regions of the Web content displayed on the screen. The first definition file may be edited via a GUI provided by the definition file creating unit 86. For example, in a case in which XHTML has been selected as a mapping destination vocabulary, a GUI may be provided using the editing functions of the HTML unit 50, which allows the user to edit the screen layout. Such a GUI allows the user to freely set the display regions of the Web content, and to freely modify the form and the layout of the display regions by mouse drag-and-drop operations. Conventional arrangements are known which provide a service that allows the user to register multiple Web content, thereby displaying the multiple Web content. However, with such conventional arrangements, available Web services and Web content are fixed beforehand. Furthermore, such conventional arrangements do not allow the user to freely design the screen layout. The document processing apparatus 100 according to the present embodiment allows the user to edit and retain the first definition file. The content integrating screen 28 is displayed according to the first definition file thus edited, thereby allowing the user to display desired Web content and Web services on the content integrating screen 28. Furthermore, such an arrangement allows the user to freely design the screen layout. Such an arrangement allows the user to make open to the public the content integrating screen 28 thus created, thereby providing a portal site.

Furthermore, with such an arrangement, the second definition file is prepared for displaying each kind of Web content, thereby allowing the user to freely set the display formats in increments of Web content. The second definition file describes rules which are used by the mapping unit 82, which is an example of a converter, for mapping an XML document to a tag set which can be processed by the document processing system installed in the document processing apparatus 100. Such an arrangement also allows the user to edit the second definition file via a GUI provided by the definition file creating unit 86. In a case in which the processing systems installed in the document processing apparatus 100 include a processing system which is capable of processing the tag set used for describing the Web content, e.g., in a case in which the Web content is described in HTML or XHTML, there is no need to prepare the second definition file. As described in the base technology, the document processing apparatus 100 according to the present embodiment is capable of processing a document described in multiple kinds of tag sets. Thus, even if the Web server 25 distributes Web content described in various kinds of tag sets, the document processing apparatus 100 is capable of appropriately processing the Web content using the second definition files prepared as necessary. In a case in which Web content is described in unique vocabularies in increments of sites, the second definition files are prepared for processing these vocabularies. Also, the document processing apparatus 100 according to the present embodiment may employ a processing system for each tag set, thereby allowing the user to appropriately edit the Web content thus displayed.

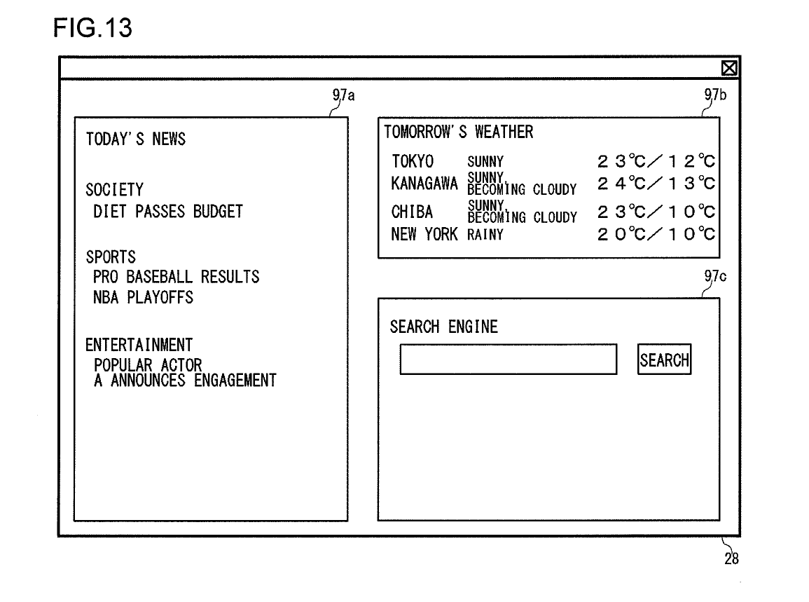

FIG. 13 shows an example of the content integrating screen 28 displayed by the display control unit 73. The content integrating screen 28 includes a region 97a for displaying the Web content “Today's News” acquired from the Web server, a region 97b for displaying the Web content “Tomorrow's Weather” acquired from the Web server, and a region 97c for displaying an interface that allows the user to transmit a query to the search engine and to display the search results thereof. The content acquisition unit 71 acquires the Web content from the respective servers. The display control unit 73 lays out the display regions of the Web content according to the display rules described in the first and second definition files, thereby displaying the Web content in the respective display regions.

With regard to this screen, the definition file creating unit 86 may provide the functions of a screen editor which receives a request for editing the content integrating screen 28. The definition file creating unit 86 may receive a request to modify the layout of the display regions of the Web content using the processing system for the tag set used to describe the content integrating screen 28, thereby editing the display rules described in the first definition file. For example, such an arrangement may allow the user to expand the region 97a by a drag-and-drop operation performed at the boundary of the region 97a. Also, such an arrangement allows the user to move the region 97a to a different location by a drag-and-drop operation, thereby changing the display position thereof. Also, such an arrangement may receive a request to register the Web content to be displayed on the content integrating screen 28. For example, an arrangement may be made in which, upon using a drag-and-drop operation to move one target Web content displayed on a different window to the content integrating screen 28, the content display rules are described in the first definition file such that the target Web content is added to the Web content displayed on the content integrating screen 28.

Such a technique allows the user to integrally display on a single screen multiple Web content provided by different Web sites. Furthermore, such an arrangement allows the user to freely design the content integrating screen which integrally displays desired Web content. Furthermore, such an arrangement allows the user to freely design the layout of the display regions of the Web content.

The display conditions retention unit 74 retains rules for changing the Web content display formats, such as color, shape, style, etc., according to the conditions with respect to the data included in the Web content. In a case in which the data included in the Web content thus acquired matches the conditions, the display control unit 73 changes the Web content display format according to the display rules retained by the display conditions retention unit 74. For example, the display conditions retention unit 74 may retain a condition according to which the display control unit 73 expands and displays news in a highlighted manner if the title of the news in the latest news content thus acquired includes the term “patent”. Such a condition for changing the display format may be described in either the first definition file or the second definition file.

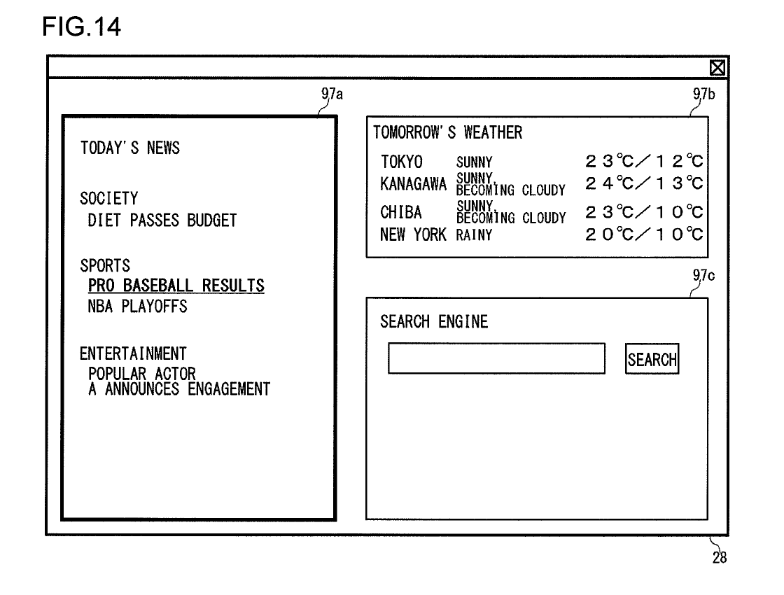

FIG. 14 shows an example of the content integrating screen 28 displayed according to the conditions retained by the display conditions retention unit 74. In a case in which the display conditions retention unit 74 retains a condition that the Web content is to be displayed in a highlighted manner if the Web content includes the keyword “professional baseball”, the content integrating screen 28 shown in FIG. 13 is displayed in a highlighted manner by the display control unit 73 as shown in FIG. 14. Such a technique improves the degree of freedom with respect to the display, thereby improving the ease of use for the user.

Upon receiving a request from the user to update the content integrating screen 28, the update control unit 75 re-acquires the Web content as necessary, and updates the display. The update control unit 75 may update a part of the content integrating screen 28. For example, an arrangement may be made in which, upon receiving from the user a notice of the part to be updated, the update control unit 75 newly acquires this part of the Web content from the server, and updates this part of the Web content. Also, the update control unit 75 may automatically determine the part to be updated. Also, an arrangement may be made in which the update control unit 75 checks whether or not the Web content provided by the server side has been updated, and re-acquires only the updated Web content. Also, there is Web content which is expected to be updated, examples of which include weather forecast content, stock price information content, etc. An arrangement may be made in which the update control unit 75 may register the update frequency for each of such Web content, and re-acquire the Web content according to the update timing.

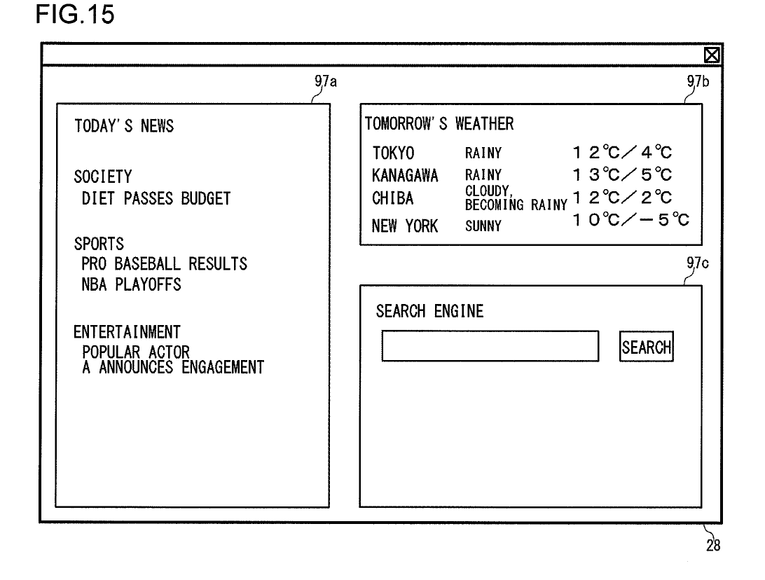

FIG. 15 shows an example of the content integrating screen 28 after a part of the Web content is updated by the update control unit 75. Upon receiving a request to update the region 97b in the content integrating screen 28 shown in FIG. 13, the update control unit 75 requests that the Web server to re-transmit the Web content “Tomorrow's Weather” displayed in the region 97b. The Web content re-acquired from the Web server is re-displayed by the processing system for processing the Web content thus acquired, thereby updating the content integrating screen 28 as shown in FIG. 15.

Such a technique provides a function of selecting and updating only the necessary part to be updated. Such an arrangement reduces the time required for update processing as compared with an arrangement which updates the entire screen. Furthermore, such an arrangement reduces the communication load.

Upon receiving from the user a request to store a document, the storage control unit 76 stores the document which is being displayed on the content integrating screen 28. In this step, if the document is being displayed via mapping processing with reference to a definition file, the document that corresponds to the source tree, which is the original document, is stored, instead of the document that corresponds to the destination tree, which is being displayed. With conventional browsers, the HTML document that is being displayed is stored. HTML is a language which mainly defines the display format. Accordingly, such conventional browsers are capable of reproducing the same screen by re-opening the document thus stored. However, such conventional browsers are unsuitable for reuse of the data included in the document. With the present embodiment, an XML document thus stored has a tag structure associated with the data, thereby facilitating the reuse of the data. Furthermore, the display format is defined by the definition file, thereby enabling the XML document to be reproduced in the same display format as it was at the point in time at which the document was stored. In addition, such an arrangement allows the user to display the document in a different display format by modifying or replacing the definition file.

In a case in which each document is edited in the display mode by its dedicated processing system, the document thus edited may be stored. Examples of such edited documents which can be stored include: a document having a portion underlined in the display mode; a document having a keyword portion displayed in a highlighted manner according to keyword extraction results; and a document having an additional note portion. With such an arrangement, the edited content can be reproduced in the following step. The note portion, the highlighted display format, etc., may be described in the document in the form of an annotation using a specific tag. Also, such additional information may be stored in a separate file. If the user desires to update the document after the document thus stored has been re-displayed, such an arrangement allows the user to select a desired part of the document to be updated, and to issue an instruction to update the part thus selected. In this case, the update control unit 75 re-acquires the updated Web content, and displays the Web content thus re-acquired, instead of the content thus stored.

The data sharing control unit 77 controls data sharing among multiple Web content displayed on the content integrating screen 28. The data sharing control unit 77 controls the content acquisition unit 71 so as to acquire the information included in the target Web content using predetermined data included in different Web content displayed on the content integrating screen 28. In an arrangement in which a search service interface is displayed on the content integrating screen 28, the data sharing control unit 77 can issue a search instruction using a term included in other Web content displayed on the content integrating screen 28, or a note edited by the user, as a search keyword. The document processing apparatus 100 processes an XML document held in the DOM format. Such an arrangement permits the use of a desired part of the document as reference data using the DOM interface, thereby realizing such data sharing in a simple manner. This technique can be called a “white box” technique, which is the opposite of a “black box” technique in which the data in a module cannot be used as reference data.

With conventional Web pages described in HTML, in order to realize such a data sharing function, the Web page must be created in a data sharing format defined beforehand. Alternatively, there is a need to develop a dedicated software component. On the other hand, the document processing apparatus 100 according of the present embodiment permits the use of desired data in the tag structure defined in XML, thereby allowing a search keyword etc., to be extracted in a simple manner. Furthermore, such an arrangement allows the user to specify the data sharing and operation using the definition file or the like. Thus, there is no need to develop an additional dedicated software component.

The data sharing control unit 77 transmits a query to the search engine with reference to the URL of the search engine described in the definition file or the source document. In this stage, desired data is selected as the content of the query from the Web content displayed on the content integrating screen 28. The position of the data to be shared may be specified by xpath. The data sharing control unit 77 transmits the data thus specified to the search engine as a search keyword, thereby acquiring the search results. The data sharing control unit 77 adds the search results thus acquired to the source tree, thereby displaying the search results on the content integrating screen 28.

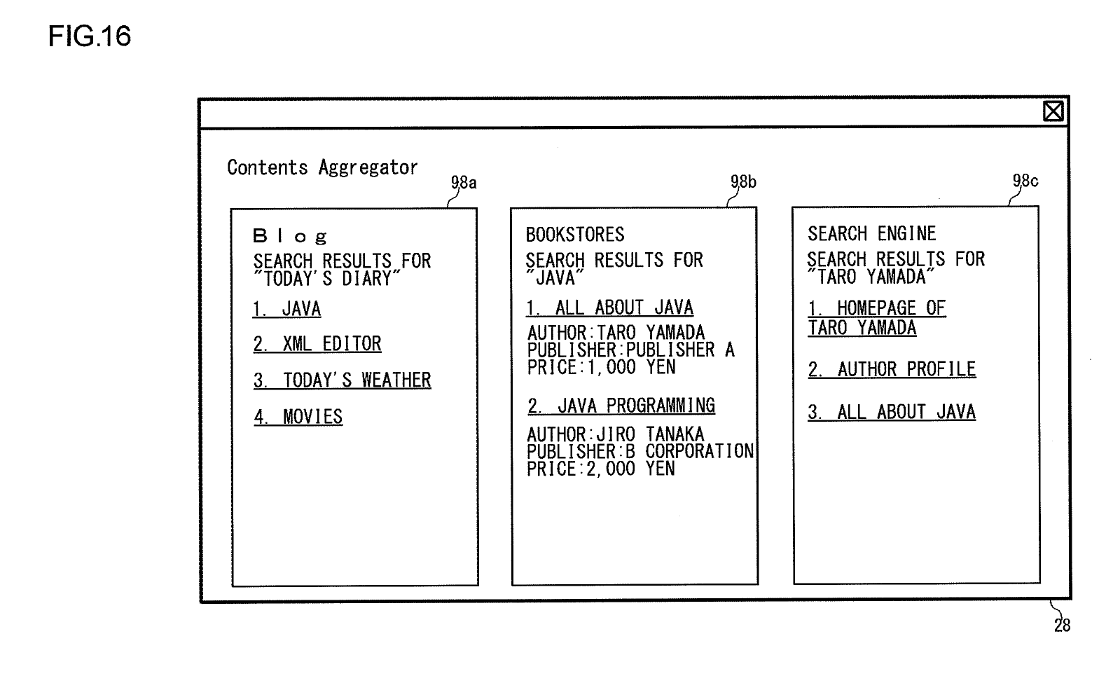

FIG. 16 shows an example of the content integrating screen 28 which displays data shared among multiple Web content by the data sharing control unit 77. The content integrating screen 28 includes: a region 98a for displaying the search results obtained by searching the blog content for a predetermined article; a region 98b for displaying the search results obtained by searching a book store site for information with respect to predetermined books; and a region 98c for displaying the search results obtained by instructing a search engine to search for Web pages that include a predetermined keyword. In an example shown in FIG. 16, the diary title which is displayed at the top of the list is extracted from the search results obtained by searching the blog content for “Today's Diary” displayed in the region 98a, and the diary title thus extracted is used in the region 98b as the search keyword for searching the book store site. Here, the book store site is searched for the information with respect to books with the diary title “Java (trademark)”, which is displayed at the top of the list, as the search keyword, and the search results are displayed in the region 98b. Furthermore, the name of the author of the book, which is displayed at the top of the list, is extracted from the search results displayed in the region 98b, and is used as the search keyword for the search engine interface displayed in the region 98c. In this example, the search engine searches for Web content using the author name “Taro Yamada”, who is the author of “All About Java (trademark)” which is displayed at the top of the list, as the search keyword. The search results thus obtained are displayed in the region 98c.

The data sharing control unit 77 may provide a GUI which allows the user to specify the data to be shared among the Web content. For example, an arrangement may be made in which, after the user selects the term “publisher” displayed in the region 98b and moves this term to the region 98c by a drag-and-drop operation, the definition file is modified such that the publisher name is extracted from the search results obtained by searching the book store site, and the publisher name thus extracted is transmitted to the search engine as a search keyword. In this example, the data sharing control unit 77 transmits “Publisher A”, which is the name of the publisher of “All About Java (trademark)” which is displayed at the top of the list, to the search engine as a search keyword. As a result, the search engine searches for Web content with “Publisher A” as a search keyword, whereupon the search results thus obtained are displayed in the region 98c.

Also, an arrangement may be made in which, when data is shared among the Web content, the data sharing control unit 77 automatically sets the layout of the display regions in the content integrating screen 28. For example, when data is shared between the Web content, the data sharing control unit 77 may display such Web content adjacently. In a case as displayed in FIG. 16, a word with a specific tag is extracted from the search results obtained by searching the book store site, and the word thus extracted is used as a search keyword for searching for blogs. Furthermore, the word with a specific tag is extracted from the search results obtained by searching for blogs, and the word thus extracted is used as a search keyword for the search engine. In this case, the data sharing control unit 77 may lay out the content integrating screen 28 such that the display regions for displaying the respective search results are arranged in order from left to right. That is to say, the data sharing control unit 77 may set the screen layout such that the search results obtained by searching the book store site, the search results obtained by searching for blogs, and the search results acquired from the search engine, are displayed in the regions 98a, 98b, and 98c, respectively.

Also, the data sharing control unit 77 may automatically set the data sharing among the Web content according to the position relation in the layout of the content integrating screen 28 displaying the Web content. For example, the data sharing control unit 77 may set the data sharing such that, when the Web content is displayed adjacently, the information with respect to one kind of Web content is acquired using predetermined data included in another kind of Web content displayed adjacently to the first kind of Web content. In a case in which the user designs the content integrating screen 28 as shown in FIG. 16, the regions 98a, 98b, and 98c, are set to be a search screen for searching for blogs, a search screen for searching the book store site, and a search engine interface, respectively. In this case, the data sharing control unit 77 may automatically share data among the Web content as follows. That is to say, predetermined data is extracted from the search results obtained by searching for blogs, and the data thus extracted is set to be the keyword for searching the bookstore site. Furthermore, predetermined data is extracted from the search results obtained by searching the bookstore site, and the data thus extracted is set to be the keyword for the search engine.

Such a technique allows the user to freely set the data sharing among the Web content. This improves the ease of use for the user with respect to the Web content.

Description has been made regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention.

Description has been made in the above embodiments regarding an arrangement for processing an XML document. Also, the document processing apparatus 100 has a function of processing other markup languages, e.g., SGML, HTML, etc.

### INDUSTRIAL APPLICABILITY

The present invention is applicable to a document processing apparatus which processes an XML document.

1. A document processing apparatus comprising:
a document acquisition unit which acquires a plurality of XML documents from a server via a network;
a definition file acquisition unit which acquires a first definition file which defines a rule for displaying the plurality of XML documents on a single screen; and
a display control unit which displays the plurality of XML documents on the single screen according to the rule defined in the first definition file.

2. A document processing apparatus according to claim 1, wherein said definition file acquisition unit further acquires a second definition file which defines a rule for displaying each of the plurality of XML documents in a display region assigned to the corresponding XML document,
and wherein said display control unit determines the layout of the display regions for displaying the plurality of XML documents according to the rule described in the first definition file,
and wherein said display control unit displays each of the XML documents in the corresponding display region according to the rule described in the second definition file.

3. A document processing apparatus according to claim 2, further comprising:
a processing system which processes a document described in a predetermined tag set; and
a conversion unit which maps the XML document to a tag set, which can be processed by said processing system, according to the rule described in the second definition file, and which retains the correspondence between the elements thus mapped.

4. A document processing apparatus according to claim 3, further comprising a storage control unit which controls the storage of the plurality of XML documents displayed on the screen,
wherein said storage control unit stores each XML document without it being converted by said conversion unit.

5. A document processing apparatus according to claim 1, further comprising a condition retention unit which retains a rule for changing a display format according to a condition with respect to data included in the XML document,
wherein, in a case in which the data included in the XML document matches the condition, said display control unit changes the display format of the XML document according to the rule.

6. A document processing apparatus according to of claim 1, further comprising an update control unit which updates at least a part of the XML document,
wherein, upon reception of information specified by a user with respect to the XML document to be updated, said update control unit instructs said document acquisition unit to re-acquire the XML document thus specified, and instructs said display control unit to display the XML document thus re-acquired.

7. A document processing apparatus according to claim 1, further comprising a screen editing unit which provides an interface for receiving a request to edit the screen which displays the plurality of XML documents,
wherein said screen editing unit receives a request to register the XML documents to be displayed on the screen,
and wherein said screen editing unit describes a rule in the first definition file, which are used for displaying the XML documents on the screen, according to the request thus received.

8. A document processing apparatus according to claim 7, wherein, upon reception of a request to modify the layout of the display regions of the XML documents displayed on the screen, said screen editing unit edits the rule described in the first definition file.

9. A document processing method comprising:
acquisition of a plurality of XML documents from a server via a network;
acquisition of a first definition file that defines a rule for displaying the plurality of XML documents on a single screen; and
display of the plurality of XML documents on a single screen according to the rule defined in the first definition file.

10. A computer program product comprising:
a module which acquires a plurality of XML documents from a server via a network;
a module which acquires a first definition file that defines a rule for displaying the plurality of XML documents on a single screen; and
a module which displays the plurality of XML documents on a single screen according to the rule defined in the first definition file.
